(19) United States
(12) Patent Application Publication
(10) Pub. No.: US 2004/0139435 A1
(43) Pub. Date: Jul. 15, 2004

(54) Associating appointments and tasks on a computer device

(76) Inventors: Yong Cui, Plano, TX (US); Roman J. Pacheco, McKinney, TX (US); Kiana Matthews, Dallas, TX (US)

Correspondence Address: TEXAS INSTRUMENTS INCORPORATED, P O BOX 655474, M/S 3999, DALLAS, TX, 75265

(21) Appl. No.: 10/635,105

(22) Filed: Aug. 6, 2003

Related U.S. Application Data
(60) Provisional application No. 60/437,592, filed on Dec. 31, 2002.

(51) Int. Cl. G06F 9/46

(52) U.S. Cl. 718/100

(57) ABSTRACT

Appointments and tasks in a software environment such as a planner or appointment book are directly associated one with the other. Embodiments of the present invention include portable computer devices such as hand-held calculators, personal digital assistants (PDA) or personal learning tools (PLT) and applications software for these devices and for personal computers. Tasks in a planner can be viewed separately or shown embedded with the task they are associated with.

### PRIORITY CLAIM

This Application claims priority of Provisional Application 60/437,592 filed Dec. 31, 2002.

### TECHNICAL FIELD OF THE INVENTION

This invention relates to electronic computing devices, and more particularly to a method for associating appointments and tasks in a time management system on an electronic computer device.

### BACKGROUND OF THE INVENTION

Prior art time management systems and planners are useful for keeping appointment schedules, calendars and task lists. Time management systems are implemented on many computer software applications and platforms. They are particularly prevalent in small portable devices such as PDAs (personal digital assistants). In these prior art time management systems and planners, tasks are typically found in “To Do” lists below are near the appointments or schedule. The tasks are things the user has listed that need to be done but are usually not an appointment. It may be something like walk the dog, fix the sink, or prepare for a meeting. The tasks in prior art systems may have a due date, but are not fully integrated with the appointment portion of the planner.

### SUMMARY OF THE INVENTION

The present invention provides appointments and tasks in a software environment such as a planner or appointment book that are directly associated one with the other. Embodiments of the present invention include portable computer devices such as hand-held calculators, personal digital assistants (PDA) or personal learning tools (PLT) and applications software for these devices and for personal computers.

In an embodiment, tasks and appointments are directly associated with one another. The tasks in a planner can be viewed separately or shown embedded with the task they are associated with.

An advantage of an embodiment of the present invention is that users can easily see what tasks are pending for each appointment since the tasks are arranged according to the associated appointment. Tasks can also be viewed in the traditional manner.

### BRIEF DESCRIPTION OF THE DRAWINGS

FIG. 1 illustrates a hand-held device having features according to the present invention.

FIGS. 2a-e illustrate the screen display of a hand-held computer device according to an embodiment of the present invention.

FIG. 3 illustrates other embodiments of the present invention.

### DETAILED DESCRIPTION OF THE INVENTION

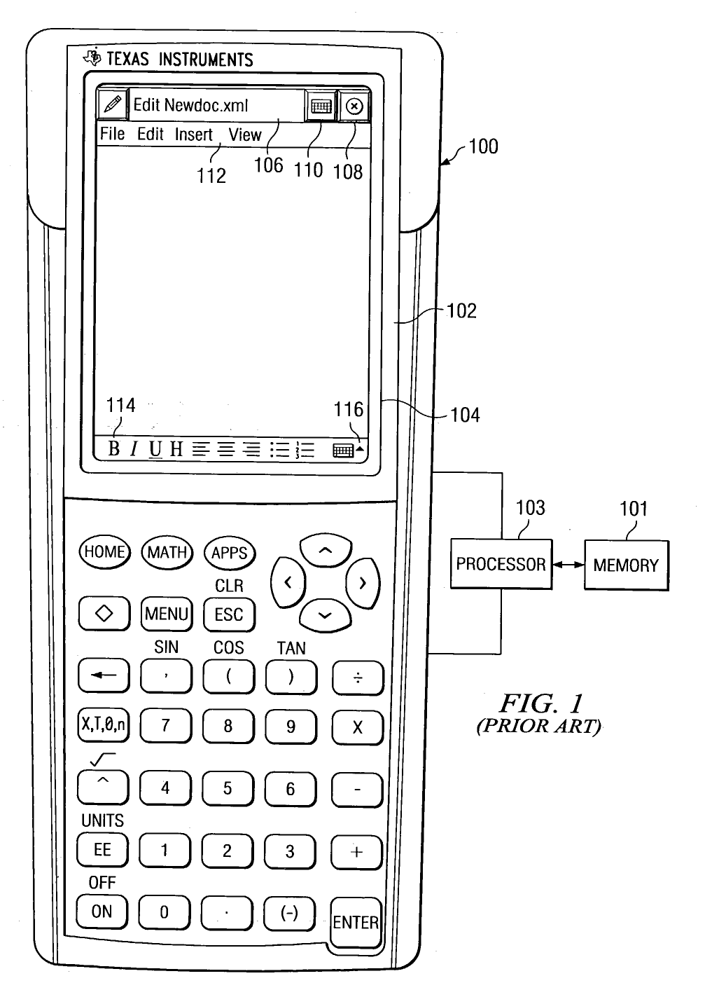

FIG. 1 illustrates a computer or hand held computing device 100 that incorporates features of the present invention. The device has a display screen 102 having a display area 104. In this embodiment, the display is a touch sensitive display that uses a stylus for input (not shown). The device executes software described herein stored in memory 101 on the micro-processor 303.

The display includes a header bar 106 that shows the current tool (in this case a document editor tool). The file name of the current open document on the display is also shown on the header bar. In addition, the header bar shows an icon for closing the tool 108 and a keyboard icon 110 to bring up a “QWERTY” keyboard on the display for input of characters with the stylus. The display area 104 further includes a top button bar 112 that has drop down menus for file, edit, insert and view functions. The display area 104 also has a bottom button bar 114 that has text formatting options, a keyboard button, and an icon 116 to pop-up another menu for inserting text symbols.

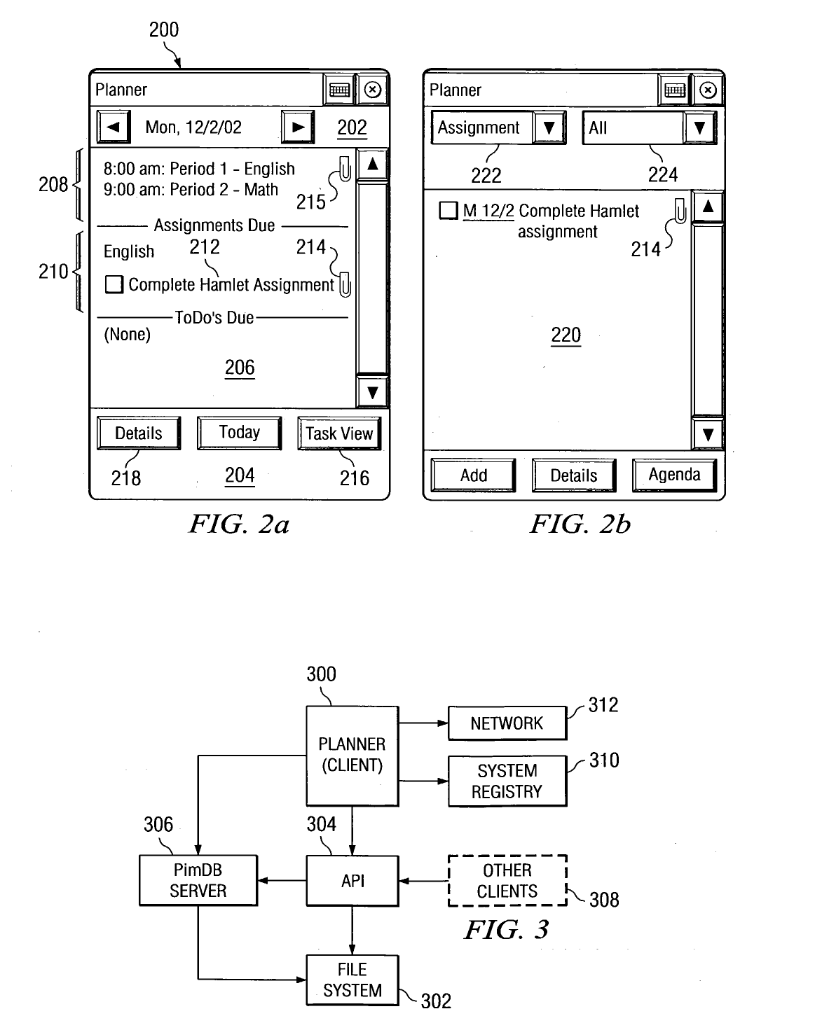

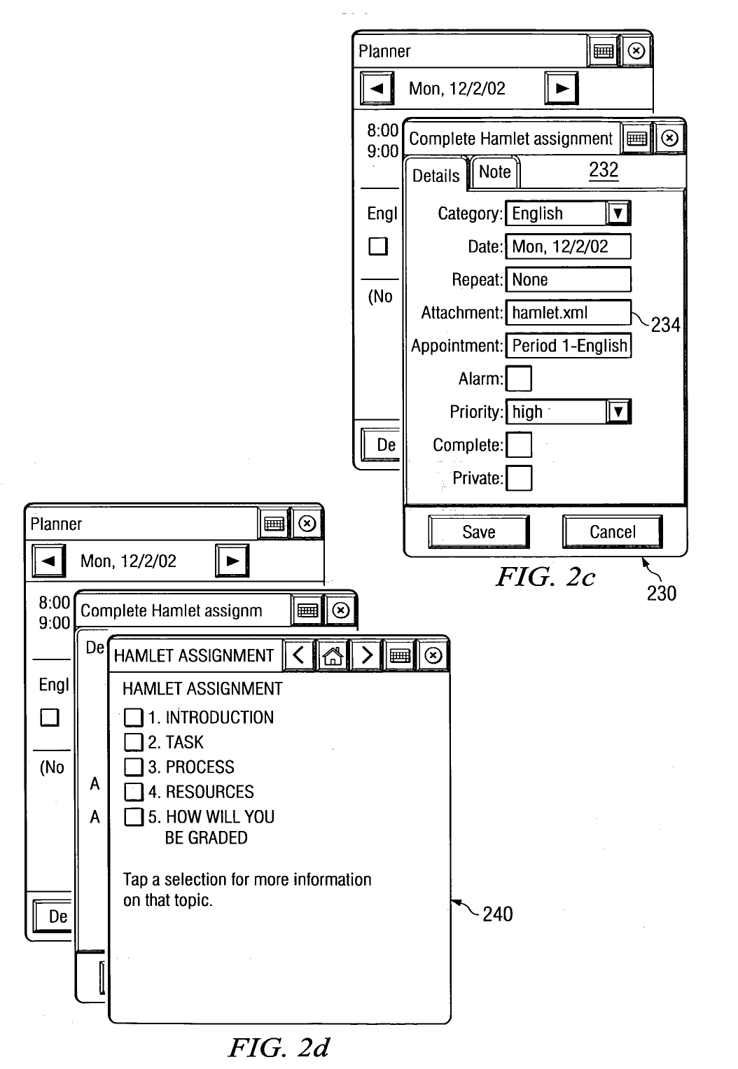

FIGS. 2a through 2d illustrate a first set of embodiments of the present invention. These figures represent screen displays for a portable computer device such as the one shown in FIG. 1. FIG. 2a shows a software application tool called “Planner.” The Planner software application is used to manage the schedule and tasks of the user. In this embodiment, the Planner is a time management application directed to a student user.

FIG. 2a illustrates a schedule view 200 of the planner application. The schedule view has a top bar 202 that shows the date of the currently displayed schedule, and has arrow buttons to move the date forward or backwards. A bottom button bar 204 has buttons for other views such as Details, Today and Task View. The details view and Task View are described further below. The Today button brings the schedule display to the current data.

The main display area of the schedule view 206 is divided into an appointment area 208 and a task area 210. The appointment area 208 shows a list of events or appointments for the current day's schedule. The task area 210 shows a list of tasks for the current day's schedule. In the illustrated embodiment directed to a student type of schedule, the tasks are divided into “Assignments Due” and “To Do's.” The distinction is that assignments are tasks for the student that must be done in response to the teacher's request, and perhaps be returned to the teacher, and the “To Do's” can be any other type of task that needs to be scheduled. (In this embodiment the tasks and appointments are associated but the task is not shown embedded in the appointment schedule, this is done in another embodiment shown below.)

The “Assignments Due” portion of the task area includes a task called “Complete Hamlet Assignment” 212. This task is associated with the English period on the schedule according to an embodiment of the present invention. This task also has an attachment, which is indicated with an attachment icon 214 next to the task description as shown. The association of the task with an appointment or schedule item allows the user to view tasks by subject as described below.

FIG. 2b illustrates a task view 220 of the planner application. The task view can be activated by selecting the “Task View” button 216 on the bottom button bar 204 shown in FIG. 2a. The task view 220 allows the user to work just with the tasks in the planner application. The type of task displayed is controlled with the task drop down box 222. In the illustrated embodiment, the Assignment tasks are displayed. The tasks displayed can be further restricted with the drop down box 224. The tasks associated with a specific category can then be displayed, such as all English or Math tasks.

FIG. 2c illustrates a task detail view 230 of the planner application. The task view can be activated by selecting the “Details” button 218 on the bottom button bar 204 shown in FIG. 2a. The task detail view 230 shows and allows entry of a variety of information details about the selected task. In the illustrated embodiment, the task detail view is shown as a cascading view partially covering the previous display. Further, the task detail view in this embodiment is divided into a details portion and a notes portion. The details portion or the notes portion is selected with a tab on the top tab bar 232. The notes portion of the task details is a screen that allows the user to enter in a text note about the task.

In a preferred embodiment, further information concerning a task is stored as shown in FIG. 2c. In particular, the task details include a link to an appointment to establish the association between a task and an appointment according to an embodiment of the present invention. In FIG. 2c, the task “complete Hamlet assignment” is associated with “Period 1—English” appointment 236. The task details may also contain such information as a task category, date the task is due, reference to one or more attachments, whether the task is repetitive (recurs at a given time interval), priority, task completion status, privacy status, etc.

FIG. 2d illustrates an attachment 240 associated with a task 212 in the planner application. The attachment for a task can be activated by selecting the attachment 234 in the task details view 232 shown in FIG. 2c, or by selecting the attachment icon 214′ in the schedule view 200 or task view 220. In the illustrated embodiment, the attachment view is shown as a cascading view partially covering the previous display. The attachment view may be a new application program that corresponds to the type of attachment file. In the illustrated embodiment, the attachment view is a text editor program that has opened a file called “Hamlet Assignment.”

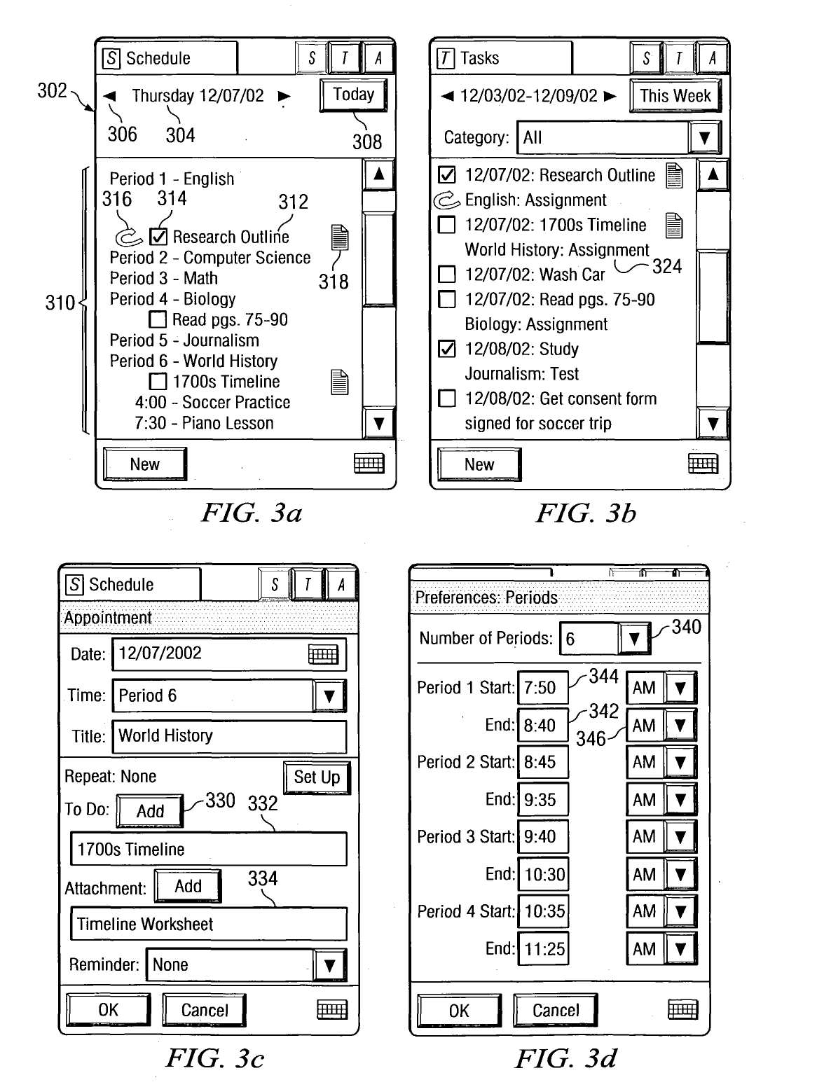

FIGS. 3a through 3d illustrate other embodiments of the present invention. These figures represent screen displays for a portable computer device such as the one shown in FIG. 1. FIG. 2a shows a software application tool called “Planner.” In this preferred embodiment, the associated tasks are embedded with the schedule items.

FIG. 3a illustrates a schedule view 300 of the planner application. A top button bar 302 has buttons for other views such as the Task View (T) and Address view (A), and the Schedule view (S), which is shown shaded to indicate the selection is not available. The details of the Task View is described below. The Address view is not described herein, but can be any PDA type tool for recording addresses and phone numbers.

Again referring to FIG. 3a, the next line of the display has the date 304 for the display with buttons 306 on each side to move the schedule display to the next or previous day. The Today button 308 brings the schedule display to the current date.

The main display area of the schedule view 310 shows a list of events or appointments for the current day's schedule. According to the present embodiment, the tasks are embedded with the appointments in this section. In this embodiment there is not separate display for tasks that are not associated with an appointment, but there could be additional display of a “To Do's,” as shown in the previous embodiments.

Each of the appointments in the display area 310 has a time and a title. The time can be indicated by an hourly time or a time period. The time periods can be set up by the user as described below. The title of the appointment is created by the user when the appointment is created in the task detail view, also described further below.

Each appointment may also have an associated task. The associated task is preferably shown below or next to the appointment with an icon or textual representation. In the illustrated embodiment, the “Period 1—English” appointment includes the task title “Research Outline” on a task line 312 after the associated appointment. The task line 312 also may also have a box 314 or other icon which can be used to show completion of the task. In this case, the box is shown with a check mark when the task is completed. Further, the task line 312 also may also have an arrow 316 or other icon which can be used to indicate when a task has been submitted or turned into the teacher. Also, the task may have an icon 318 to indicate whether there is also an associated attachment with the task. This feature is described further in a co-filed application by the inventors herein.

FIG. 3b illustrates a task view 320 of the planner application. The task view is displayed when the user selects the task view button in the top bar 302 of the schedule view of FIG. 3a as described above. The task view has a date bar and this week button similar to those describe for the schedule view. A category button 322 with a drop down menu can be used to select which category of tasks are to be displayed. Similarly, other buttons could be used to determine the display order of the tasks. Each of the tasks in the task view are shown with the task date followed by the task title. In a preferred embodiment, tasks that are associated with an appointment are followed by a reference to the appointment 324. Some tasks may not be associated with an appointment, such as the task “Wash Car” 326.

FIG. 3c illustrates the appointment detail view 320 of the planner application. This view is displayed when the user selects the “new” button 324 in the schedule view shown in FIG. 3a. The user can create a new appointment or edit an existing one with the appointment detail view. The appointment is defined by setting a date, time and title for the new appointment. The user can add one or more tasks to be associated with the appointment by selecting the “Add” button for a new “To Do” 330. The user can then input a task title 332 in a title box 332 as shown. The task will then be displayed with the appointment as described above. Similarly, attachments 334 can also be associated with the appointment as described in a co-filed application.

FIG. 3d illustrates the periods preference view of the planner application. This view is displayed when the user selects the “Preference” pull down menu item. This view allows the user to select the number of periods in the day with a drop down box 340. Subsequently, the user may then assign a time period for each of the time periods. In a preferred embodiment, each time period has a start time box 342 and end time box 344 and a drop down box 346 to indicate AM or PM.

Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator or other handheld device.

What is claimed is:

1. An article comprising a medium storing software that causes a processor-based computer system to perform the following steps:
a. create an appointment entry in a time management application; and
b. associate a task directly with the appointment.

2. The article of claim 1 wherein associating the task includes displaying a plurality of tasks next to an appointment for which the task is related.

3. The article of claim 1 wherein associating the task includes linking related tasks and appointments in a data base to maintain the relationship of the tasks and allow the user to create and edit the linked relationships.

4. The article of claim 3 wherein the task is in an assignments due list of a calendar time management application.

5. The article of claim 3 wherein the time periods in the calendar time management application are class periods.

6. A system, comprising:
a. a processor;
b. a memory coupled to the processor; and
c. a storage medium coupled to the processor including a software program that, upon execution:
i. create an appointment entry in a time management application; and
ii. associate a task directly with the appointment.

7. The article of claim 6 wherein associating the task includes displaying a plurality of tasks next to an appointment for which the task is related.

8. The article of claim 6 wherein associating the task includes linking related tasks and appointments in a data base to maintain the relationship of the tasks and allow the user to create and edit the linked relationships.

9. The article of claim 8 wherein the task is in an assignments due list of a calendar time management application.

10. The article of claim 8 wherein the time periods in the calendar time management application are class periods.

11. A portable computing device, comprising:
a. a processor;
b. a memory coupled to the processor; and
c. a storage medium coupled to the processor including a software program that, upon execution:
i. create an appointment entry in a time management application; and
ii. associate a task directly with the appointment.

12. The article of claim 6 wherein associating the task includes displaying a plurality of tasks next to an appointment for which the task is related.

13. The article of claim 6 wherein associating the task includes linking related tasks and appointments in a data base to maintain the relationship of the tasks and allow the user to create and edit the linked relationships.

14. The article of claim 8 wherein the task is in an assignments due list of a calendar time management application.

15. The article of claim 8 wherein the time periods in the calendar time management application are class periods.
